(19) United States
(12) Patent Application Publication
(10) Pub. No.: US 2025/0167407 A1
(43) Pub. Date: May 22, 2025

(54) Busbar Assembly Configured Such that Temperature of Busbar is Easily Measured and Battery Pack Including the Same

(71) Applicant: LG Energy Solution, Ltd., Seoul (KR)

(72) Inventor: Sun Woo Yun, Daejeon (KR)

(73) Assignee: LG Energy Solution, Ltd., Seoul (KR)

(21) Appl. No.: 18/841,576

(22) PCT Filed: Sep. 22, 2023
(86) PCT No.: PCT/KR2023/014461

§ 371 Date: Aug. 26, 2024

(30) Foreign Application Priority Data
Oct. 4, 2022 (KR) 10-2022-0126180

(51) Int. Cl. H01M 50/522; H01M 50/204; H01M 50/505; H01M 50/569; H01M 50/588; H01M 50/591

(52) U.S. Cl. CPC H01M 50/522; H01M 50/505; H01M 50/569; H01M 50/588; H01M 50/591; H01M 50/204

(57) ABSTRACT

A busbar assembly includes a busbar made of a copper material, a cover member configured to wrap around a first portion of the busbar, a cover cap located so as to wrap around one end of the cover member from which a second portion of the busbar protrudes, and a thermistor assembly positioned such that the cover cap wraps around the thermistor assembly while the thermistor assembly is in tight contact with the busbar. The cover cap includes a first receiving portion and a second receiving portion. The first receiving portion is located along the second portion of the busbar, and the second receiving portion is located between the first receiving portion and the cover member. A battery pack including the busbar assembly is also provided.

### CROSS-REFERENCE TO RELATED APPLICATIONS

The present application is a national phase entry under 35 U.S.C. § 371 of International Application No. PCT/KR2023/014461, filed on Sep. 22, 2023 which claims priority from Korean Patent Application No. 2022-0126180 filed on Oct. 4, 2022, the disclosures of which are incorporated herein by reference in their entirety.

### FIELD OF THE INVENTION

The present disclosure relates to a busbar assembly configured such that the temperature of a busbar is easily measured, as well as and a battery pack including the same More particularly, this disclosure relates to a busbar assembly configured such that the temperature of a busbar is easily measured, wherein change in temperature of the busbar is measured and verified in real time, as well as a battery pack including the same.

### Background Art

With recent development of alternative energies due to air pollution and energy depletion caused as the result of use of fossil fuels, demand for secondary batteries capable of storing electrical energy has increased. Secondary batteries, which are capable of being charged and discharged, are intimately used in daily life. For example, secondary batteries are used in mobile devices, electric vehicles, and hybrid electric vehicles.

Required capacities of secondary batteries used as energy sources for various kinds of electronic devices used in modern society have increased due to an increase in usage of mobile devices, increasing complexity of the mobile devices, and development of electric vehicles. In order to satisfy demand of users, a plurality of battery cells can be disposed in a small-sized device, whereas a battery module including a plurality of battery cells electrically connected to each other or a battery pack including a plurality of battery modules is used in a vehicle, etc.

In a battery pack, current flows in a busbar can be quite high relative to the area of the busbar, due to increased output for fast charging, high capacity, and light weight, such that the importance of detecting and measuring a change in temperature of the busbar has increased.

FIG. 1 is a perspective view showing a conventional busbar. As shown in FIG. 1, a conventional flexible busbar assembly includes a busbar 10 configured to electrically connect adjacent battery modules to each other and a cover member 20 configured to wrap the busbar 10.

A specific part of the conventional flexible busbar assembly may be deformed into a desired shape, for example by bending, in order to easily electrically connect battery modules provided on a complex path to each other.

In the conventional flexible busbar assembly, however, a separate temperature measurement device configured to measure the temperature of the busbar 10 is not provided, and even though a temperature measurement device is provided, a means configured to fix the temperature measurement device to the busbar 10 in tight contact is not provided.

It is not easy to bring the temperature measurement device into direct contact with the busbar 10, such that the reliability of the temperature measurement value of the busbar 10 may be reduced.

### BRIEF SUMMARY

### Technical Problem

The present disclosure has been made in view of the above problems, and it is an object of the present disclosure to provide a busbar assembly (and a battery pack including the same) that is configured such that a temperature measurement device is fixed to a busbar in direct contact with the busbar.

It is another object of the present disclosure to provide a busbar assembly (and a battery pack including the same) that is configured such that the temperature of a busbar is measured in real time by direct contact with the busbar, so as to improve reliability of a temperature value of the busbar.

### Technical Solution

A busbar assembly according to the present disclosure to accomplish the above objects includes a busbar (100) made of a copper material, a cover member (200) configured to wrap a part of the busbar (100), a cover cap (300) located so as to wrap one side of the cover member (200) and the busbar (100) protruding from the one side of the cover member (200), and a thermistor assembly (400) located so as to be wrapped by the cover cap (300), the thermistor assembly being in tight contact with the busbar (100), wherein the cover cap (300) is provided with a first receiving portion (310) located at a part of the busbar (100) protruding toward the one side of the cover member (200) and a second receiving portion (320) located between the first receiving portion (310) and the cover member (200).

Also, in the busbar assembly according to the present disclosure, the cover cap (300) may be made of an electrically insulative and elastic material.

Also, in the busbar assembly according to the present disclosure, the material may include at least one of silicone, rubber, polyurethane, mica, a plastic resin, glass fiber woven fabric, and a mixture of mPPO and glass fiber.

Also, in the busbar assembly according to the present disclosure, the thermistor assembly (400) may include a tight-contact plate (410) in tight contact with the busbar (100), a thermistor (420) attached to the tight-contact plate (410), the thermistor being configured to measure temperature, and a wire (430) connected to the thermistor (420) so as to extend out of the cover cap (300).

Also, in the busbar assembly according to the present disclosure, the thermistor (420) may be received in the second receiving portion (320).

Also, in the busbar assembly according to the present disclosure, the second receiving portion (320) may be formed so as to have a size such that an inner surface of the second receiving portion (320) is in tight contact with the thermistor (420).

Also, in the busbar assembly according to the present disclosure, the second receiving portion (320) may be formed so as to have a shape and a size such that the inner surface of the second receiving portion (320) is spaced apart from the thermistor (420).

Also, in the busbar assembly according to the present disclosure, the tight-contact plate (410) may be made of an electrically insulative and thermally conductive material.

Also, in the busbar assembly according to the present disclosure, an adhesive tape (500) configured to fix the tight-contact plate (410) may be attached to a lower surface of the tight-contact plate (410).

Also, in the busbar assembly according to the present disclosure, the tight-contact plate (410) may have an area greater than the horizontal sectional area of the second receiving portion (320).

Also, in the busbar assembly according to the present disclosure, the cover cap (300) may be provided with a recess (330) having a predetermined depth such that the wire (430) can be inserted into the recess.

Also, in the busbar assembly according to the present disclosure, the cover cap (300) may be provided with an inclined portion (340) inclined at a predetermined angle from a lower end of the second receiving portion (320) in a direction toward the recess (330).

Also, in the busbar assembly according to the present disclosure, an adhesive tape (500) configured to fix the wire (430) may be attached to a lower surface of the wire (430).

In addition, the present disclosure provides a battery pack including a busbar assembly having the aforementioned features.

### Advantageous Effects

As is apparent from the above description, a busbar assembly according to the present disclosure has an advantage in that a cover cap is provided, whereby it is possible to easily fix a thermistor assembly when the temperature of a busbar is measured through the thermistor assembly while the insulated state of the busbar is maintained.

In addition, the busbar assembly according to the present disclosure has an advantage in that a thermistor of the thermistor assembly can directly measure the temperature of the busbar, whereby the accuracy and rapidness of measurement results are improved.

### DESCRIPTION OF DRAWINGS

FIG. 1 is a perspective view of a conventional busbar.

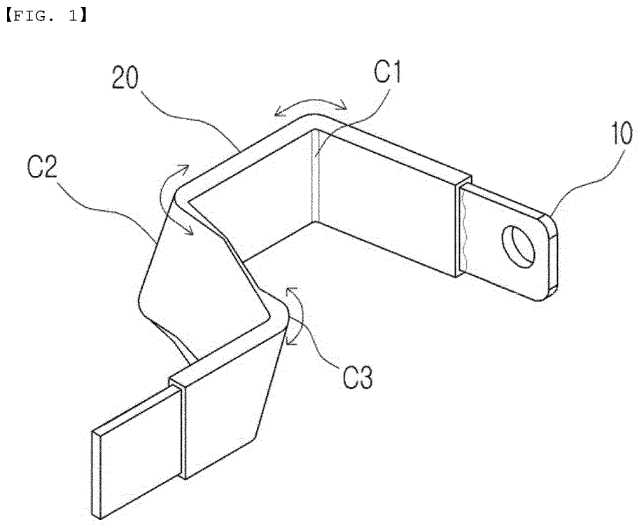

FIG. 2 is a perspective view of a busbar assembly according to a first preferred aspect of the present disclosure.

FIG. 3 is a vertical sectional view of the busbar assembly according to the first preferred aspect of the present disclosure.

FIG. 4 is a sectional view taken along line A-A of FIG. 3.

FIG. 5 is a sectional view taken along line B-B of FIG. 3.

FIG. 6 is a vertical sectional view of a busbar assembly according to a second preferred aspect of the present disclosure.

FIG. 7 is a sectional view taken along line A-A of FIG. 6.

FIG. 8 is a vertical sectional view of a busbar assembly according to a third preferred aspect of the present disclosure.

FIG. 9 is a sectional view taken along line A-A of FIG. 8.

FIG. 10 is a vertical sectional view of a busbar assembly according to a fourth preferred aspect of the present disclosure.

FIG. 11 is a sectional view taken along line A-A of FIG. 10.

### DETAILED DESCRIPTION

Preferred aspects of the present disclosure will now be described in detail with reference to the accompanying drawings such that the preferred aspects of the present disclosure can be easily implemented by a person having ordinary skill in the art to which the present disclosure pertains. In describing the principle of operation of the preferred aspects of the present disclosure in detail, however, a detailed description of known functions and configurations incorporated herein will be omitted when the same may obscure the subject matter of the present disclosure.

In addition, the same reference numbers will be used throughout the drawings to refer to parts that perform similar functions or operations. In the case in which one part is said to be connected to another part throughout the specification, not only may the one part be directly connected to the other part, but also, the one part may be indirectly connected to the other part via a further part. In addition, the fact that a certain element is included does not mean that other elements are excluded, but rather means that such elements may be further included unless mentioned otherwise.

Hereinafter, a busbar assembly configured such that the temperature of a busbar is easily measured according to the present disclosure and a battery pack including the same will be described in detail with reference to the accompanying drawings.

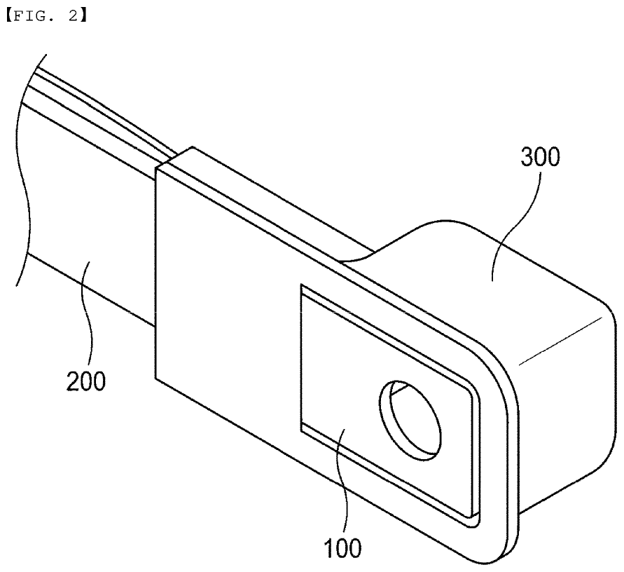

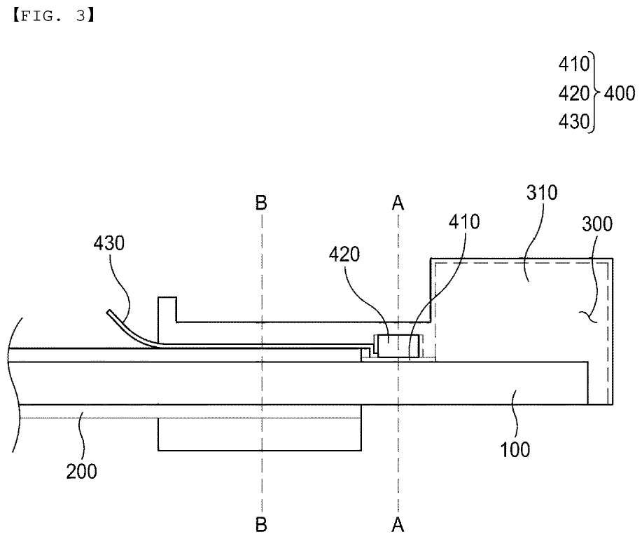

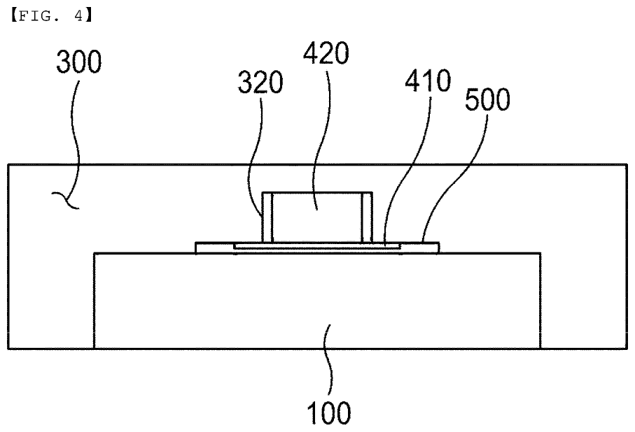

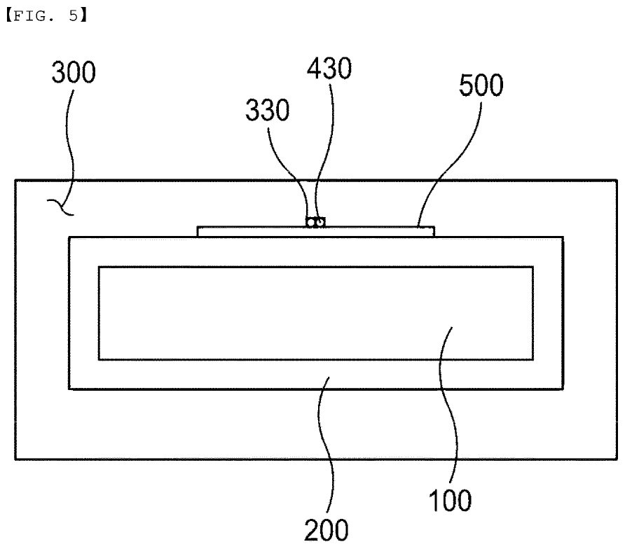

FIG. 2 is a perspective view showing a busbar assembly according to a first preferred aspect of the present disclosure; FIG. 3 is a sectional view of the busbar assembly according to the first preferred aspect of the present disclosure, cut in a vertical direction; FIG. 4 is a sectional view taken along line A-A of FIG. 3 and FIG. 5 is a sectional view taken along line B-B of FIG. 3.

As shown in FIGS. 2 to 5, the busbar assembly according to the present disclosure includes a busbar 100, a cover member 200, a cover cap 300, and a thermistor assembly 400.

The busbar 100 may be made of a flat copper material, and each of opposite ends of the busbar 100 may be electrically connected to a battery module adjacent thereto.

The cover member 200 may wrap around a part of the busbar 100 to prevent short circuit due to contact between the busbar 100 and metal components adjacent thereto.

The cover member 200 may be located so as to wrap around a middle part of the busbar 100, excluding the ends. As described above, the cover member 200 may be made of an electrically insulative material to prevent contact between the busbar 100 and a metal adjacent thereto, and the cover member 200 may be made of an elastic material to protect the busbar 100 from external impact, as needed.

As an example, the cover member 200 may be made of a material including at least one of silicone, rubber, polyurethane, mica, a plastic resin, glass fiber woven fabric, and a mixture of modified Polyphenylene Oxide (mPPO) and glass fiber. However, the material for the cover member 200 is not limited thereto, as long as the state in which the cover member 200 wraps around the busbar 100 is maintained and contact between the busbar 100 and a metal material adjacent thereto is prevented, whereby insulation of the busbar 100 is maintained.

The cover cap 300 may be located so as to wrap around each end of the busbar 100 that is not wrapped by the cover member 200 and a part of the cover member 200.

A first receiving portion 310, which defines a predetermined space, may be formed in a part of the cover cap 300 protruding toward one side of the cover member 200, and a second receiving portion 320 may be formed between the first receiving portion 310 and the cover member 200.

The first receiving portion 310 is a space in which a bolt and a nut may be received when the busbar 100 is connected to a battery module or the like using the bolt and the nut, whereby it is possible to maintain insulation of the bolt and the nut fastened to the busbar 100.

The second receiving portion 320 may be formed between the first receiving portion 310 and the cover member 200, and may define a predetermined space to receive the thermistor assembly 400.

The second receiving portion 320 may block contact between the thermistor assembly 400 received therein and a metal member adjacent e.g., thereto, a module case configured to receive a battery cell, thereby preventing short circuit.

A recess 330, which is a space in which a wire 430 of the thermistor assembly 400 is received, may be formed at the position at which the wire 430 and the cover cap 300 are in tight contact with each other.

The recess 330 may wrap around the wire 430 to protect the wire 430 from external impact.

Next, the assembly thermistor 400, which is configured to measure the temperature of the busbar 100, may include a tight-contact plate 410, a thermistor 420, and a wire 430.

The tight-contact plate 410 may be flat, may be made of a thermally conductive and electrically insulative material, and may be located under the second receiving portion 320.

The tight-contact plate 410 may be formed so as to have an area greater than the horizontal sectional area of the second receiving portion 320, and may support the thermistor 420 located at an upper surface thereof.

The thermistor 420 is received in the second receiving portion 320, and may be a sensor located at the upper surface of the tight-contact plate 410 to measure the temperature of the busbar 100.

The thermistor 420 has the advantage of measuring the temperature of the busbar 100 transmitted through the tight-contact plate 410 in real time, whereby it is possible to immediately respond to change in temperature of the busbar 100.

The second receiving portion 320, which receives the thermistor 420, may be formed so as to have a size capable of being in tight contact with the thermistor 420, whereby it is possible to protect the thermistor 420 from external impact.

One side of the wire 430 may be connected to the thermistor 420, and the other side of the wire may be connected to a control component, such as a battery management system (BMS).

The wire 430 allows a temperature measurement value and a signal of the busbar 100 measured by the thermistor 420 to be transmitted to the control member (not shown).

An adhesive tape 500 may be formed at each of a lower surface of the tight-contact plate 410 and a lower surface of the wire 430 received in the recess 330 to fix the tight-contact plate 410 and the wire 430.

The adhesive tape 500 may be made of a thermally conductive and electrically insulative material, e.g., an epoxy resin; however, the material for the adhesive tape 500 is not limited thereto as long as the adhesive tape 500 is thermally conductive and electrically insulative, is capable of fixing the tight-contact plate 410 and the wire 430, and is capable of transferring heat generated by the busbar 100 to the tight-contact plate 410.

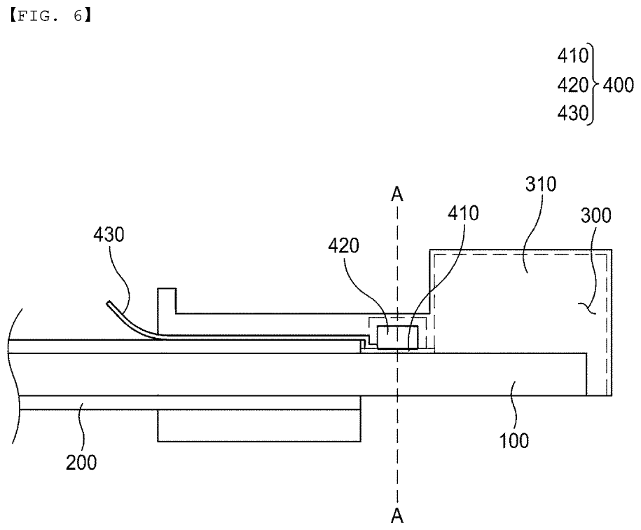

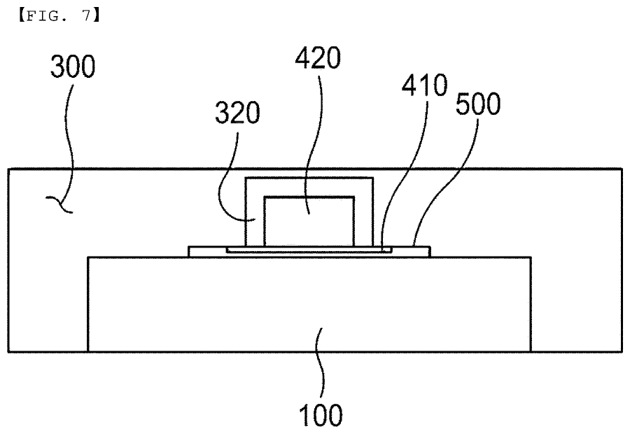

FIG. 6 is a sectional view of a busbar assembly according to a second preferred aspect of the present disclosure, cut in the vertical direction, and FIG. 7 is a sectional view taken along line A-A of FIG. 6.

Referring to FIGS. 6 and 7, the busbar assembly according to the second preferred aspect of the present disclosure is identical to the busbar assembly according to the first aspect described with reference to FIGS. 2 to 5 except for the size of a second receiving portion 320, and therefore a description of the same configuration will be omitted.

In the busbar assembly according to the second aspect of the present disclosure, the second receiving portion 320 may be formed so as to have a shape and a size such that an inner surface of the second receiving portion 320 and a thermistor 420 are spaced apart from each other so as not to be in contact with each other.

The second receiving portion 320 according to the second aspect has the advantage of being spaced apart from the thermistor 420 such that an empty space is defined between the second receiving portion 320 and the thermistor 420 and the empty space serves as a buffer against external impact.

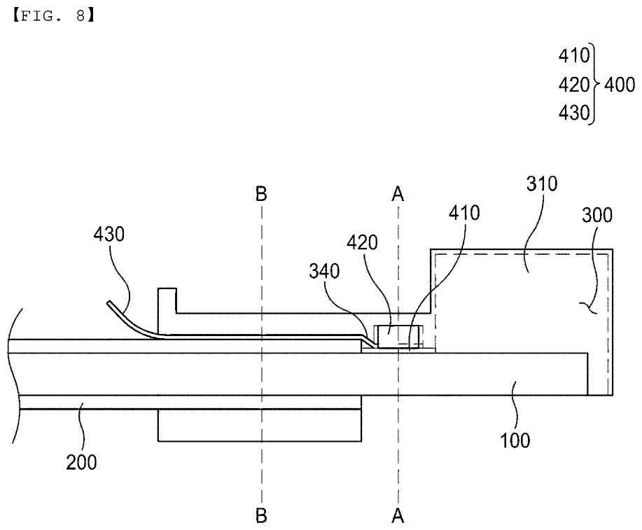

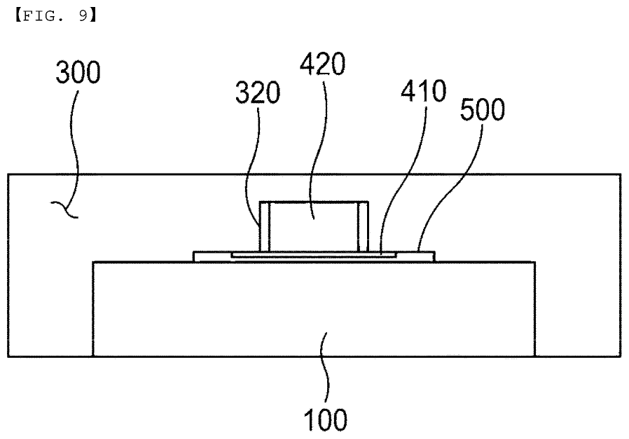

FIG. 8 is a sectional view of a busbar assembly according to a third preferred embodiment of the present disclosure, cut in the vertical direction, and FIG. 9 is a sectional view taken along line A-A of FIG. 8.

Referring to FIGS. 8 and 9, the busbar assembly according to the third preferred aspect of the present disclosure is identical to the busbar assembly according to the first aspect described with reference to FIGS. 2 to 5 except that an inclined portion 340 is formed at a cover cap 300, and therefore a description of the same configuration will be omitted.

In the busbar assembly according to the third aspect, the cover cap 300 is provided with an inclined portion 340 inclined at a predetermined angle from a lower end of a second receiving portion 320 in a direction toward a recess 330.

The inclined portion 340 is formed such that the angle of a bent part of a wire 430 is gentle, which has the advantage of eliminating damage to the wire 430 due to bending.

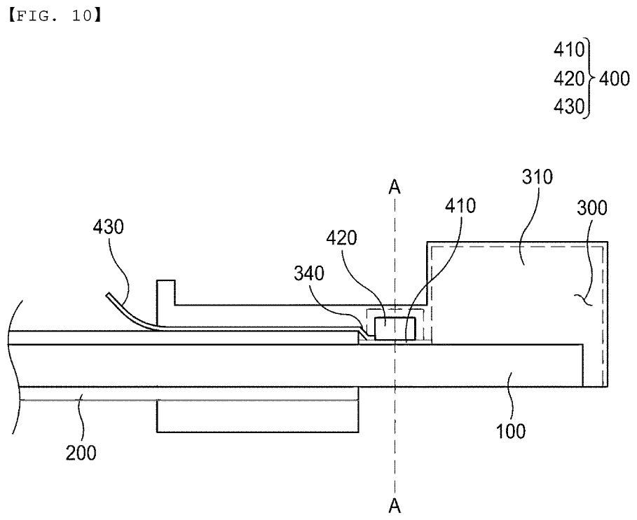

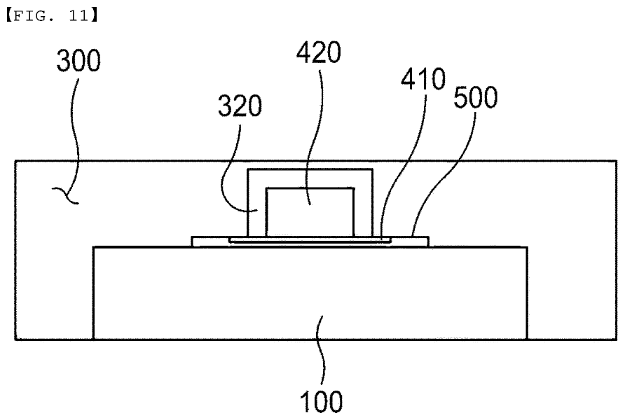

FIG. 10 is a sectional view of a busbar assembly according to a fourth preferred aspect of the present disclosure, cut in the vertical direction, and FIG. 11 is a sectional view taken along line A-A of FIG. 10.

Referring to FIGS. 10 and 11, the busbar assembly according to the fourth preferred aspect of the present disclosure is identical to the busbar assembly according to the first aspect described with reference to FIGS. 2 to 5 except for the size of a second receiving portion 320 and an inclined portion 340 formed at a cover cap 300, and therefore a description of the same configuration will be omitted.

In the busbar assembly according to the fourth aspect of the present disclosure, the second receiving portion 320 may be formed so as to have a size and a shape such that the second receiving portion 320 is spaced apart from a thermistor 420 received in the second receiving portion 320, and an empty space defined between the second receiving portion 320 and the thermistor 420 may serve as a buffer against external impact.

The inclined portion 340 may be formed so as to be inclined at a predetermined angle from a lower end of the second receiving portion 320 in a direction toward a recess 330, whereby the angle of a bent part of a wire 430 extending from the lower end of the second receiving portion 320 in the direction toward the recess 330 may be gentle, which has the advantage of reducing damage to the wire 430 due to bending.

In addition, the present disclosure may provide a battery pack including the busbar assembly and a device having the battery pack mounted therein.

Those skilled in the art to which the present disclosure pertains will appreciate that various applications and modifications are possible within the category of the present disclosure based on the above description.

### DESCRIPTION OF REFERENCE NUMERALS

100: Busbar
200: Cover member
300: Cover cap
310: First receiving portion
320: Second receiving portion
330: Recess
340: Inclined portion
400: Thermistor assembly
410: Tight-contact plate
420: Thermistor
430: Wire
500: Adhesive tape

1. A busbar assembly comprising:
a busbar made of electrically conductive material;
a cover member configured to wrap around a first portion of the busbar;
a cover cap located so as to wrap around a second portion of the busbar; and
a thermistor assembly positioned such that the cover cap wraps around the thermistor assembly, the thermistor assembly being in tight contact with the busbar, wherein
the cover cap includes a first receiving portion and a second receiving portion, the first receiving portion located along the second portion of the busbar, and the second receiving portion located between the first receiving portion and the cover member.

2. The busbar assembly according to claim 1, wherein the cover cap is made of a material that is electrically insulative and elastic.

3. The busbar assembly according to claim 2, wherein the material includes at least one of silicone, rubber, polyurethane, mica, a plastic resin, glass fiber woven fabric, and a mixture of mPPO and glass fiber.

4. The busbar assembly according to claim 1, wherein the thermistor assembly includes:
a plate in tight contact with the busbar;
a thermistor attached to the plate, the thermistor being configured to measure temperature; and
a wire connected to the thermistor and extending out of the cover cap.

5. The busbar assembly according to claim 4, wherein the thermistor is positioned in the second receiving portion.

6. The busbar assembly according to claim 5, wherein the second receiving portion is configured such that an inner surface of the second receiving portion is in tight contact with the thermistor.

7. The busbar assembly according to claim 5, wherein the second receiving portion is configured such that an inner surface of the second receiving portion is spaced apart from the thermistor.

8. The busbar assembly according to claim 4, wherein the plate comprises a material that is electrically insulative and thermally conductive.

9. The busbar assembly according to claim 4, further comprising an adhesive tape for securing the tight-contact plate, the adhesive tape being attached to a lower surface of the plate.

10. The busbar assembly according to claim 4, wherein the plate has an area greater than a horizontal sectional area of the second receiving portion.

11. The busbar assembly according to claim 4, wherein the cover cap includes a recess having a predetermined depth such that the wire can be received within the recess.

12. The busbar assembly according to claim 11, wherein the cover cap includes an inclined portion inclined at a predetermined angle from a lower end of the second receiving portion in a direction toward the recess.

13. The busbar assembly according to claim 4, further comprising an adhesive tape for securing the wire is attached to a lower surface of the wire.

14. A battery pack including the busbar assembly according to claim 1.

15. The busbar assembly according to claim 4, wherein the cover cap is located so as to wrap around one side of the cover member.
